(19) United States
(12) Patent Application Publication
(10) Pub. No.: US 2018/0312141 A1
(43) Pub. Date: Nov. 1, 2018

(54) METHODS AND APPARATUS FOR APPLICATION OF WASHER FLUID TO VEHICLE CAMERAS

(71) Applicant: Ford Global Technologies, LLC, Dearborn, MI (US)

(72) Inventors: Mahmoud Yousef Ghannam, Canton, MI (US); David James Tippy, Ann Arbor, MI (US); Steven Yellin Schondorf, Dearborn, MI (US)

(21) Appl. No.: 15/499,818

(22) Filed: Apr. 27, 2017

(51) Int. Cl. B60S 1/52; B60R 1/00; B60S 1/56; B60S 1/50; B60S 1/54; B60S 1/48

(52) U.S. Cl. CPC B60S 1/52; B60R 1/00; B60S 1/56; B05B 12/00; B60S 1/54; B60S 1/481; B60S 1/50

(57) ABSTRACT

Method and apparatus are disclosed for methods and apparatus for application of washer fluid to vehicle cameras. An example vehicle includes a camera including a lens. The example vehicle includes a reservoir and a flexible housing defining a cavity fluidly coupled to the reservoir and including an outlet valve adjacent the lens. The example vehicle also includes a solenoid coupled to the flexible housing to affect a cavity pressure by flexing the flexible housing. The outlet valve opens upon the cavity pressure being greater than a predetermined threshold to spray the washer fluid onto the lens.

### TECHNICAL FIELD

The present disclosure generally relates to washer fluid and, more specifically, to methods and apparatus for application of washer fluid to vehicle cameras.

### BACKGROUND

Typically, vehicles include windshields, such as a front windshield and a rear windshield, through which a driver and/or other occupant views a surrounding area. Some vehicles also include external cameras that capture image(s) and/or video of the surrounding area. In some instances, the image(s) and/or video captured by camera(s) are presented to the driver to facilitate the driver in operating the vehicle. In other instances, the captured image(s) and/or video are analyzed to facilitate autonomous or semi-autonomous operation of the vehicle. Oftentimes, washer fluid is applied to the windshields and/or the external cameras when dirt and/or other material is located on the windshields and/or the external cameras.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for methods and apparatus for application of washer fluid to vehicle cameras. An example disclosed vehicle includes a camera including a lens. The example disclosed vehicle includes a reservoir and a flexible housing defining a cavity fluidly coupled to the reservoir and including an outlet valve adjacent the lens. The example disclosed vehicle also includes a solenoid coupled to the flexible housing to affect a cavity pressure by flexing the flexible housing. The outlet valve opens upon the cavity pressure being greater than a predetermined threshold to spray the washer fluid onto the lens.

An example disclosed method for washing vehicle cameras includes sending a signal to a solenoid via a washer fluid controller of a vehicle, actuating an armature of the solenoid to flex a flexible housing to affect a pressure within a cavity defined by the flexible housing, and opening an outlet valve of the flexible housing upon the pressure being greater than a predetermined threshold to spray washer fluid from the flexible housing onto a camera lens.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example vehicle in accordance with the teachings herein.

FIG. 2 illustrates an example washer fluid module of the vehicle of FIG. 1 in accordance with the teachings herein.

FIG. 3 illustrates another example washer fluid module of the vehicle of FIG. 1 in accordance with the teachings herein.

FIG. 4 illustrates another example washer fluid module of the vehicle of FIG. 1 in accordance with the teachings herein.

FIG. 5 is a block diagram of electronic components of the vehicle of FIG. 1.

FIG. 6 is a flowchart for applying washer fluid to a camera of the vehicle of FIG. 1 via the washer fluid module of FIG. 2, the washer fluid module of FIG. 3, and/or the washer fluid module of FIG. 4 in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

Typically, vehicles include windshields, such as a front windshield and a rear windshield, through which a driver and/or other occupant views a surrounding area. Some vehicles also include external cameras that capture image(s) and/or video of the surrounding area. In some instances, the image(s) and/or video captured by camera(s) are presented to the driver to facilitate the driver in operating the vehicle. In other instances, the captured image(s) and/or video are analyzed to facilitate autonomous or semi-autonomous operation of the vehicle. Oftentimes, washer fluid is applied to the windshields and/or the external cameras when dirt and/or other material is located on the windshields and/or the external cameras. In some such instances, the washer fluid is applied in such a manner that the dirt and/or other material remains on a lens of an external camera upon the washer fluid being applied. Further, in some such instances, the washer fluid is not applied to the lens of the external camera in a timely manner upon the dirt and/or other material collecting on the lens of the external camera.

Example methods and apparatus disclosed herein include a washer fluid module that maintains a clean lens of a camera (e.g., a rearview camera) of a vehicle to facilitate performance of motive functions (e.g., manual, autonomous, semi-autonomous) of the vehicle. The washer fluid module of examples disclosed herein includes a reservoir that contains washer fluid and a flexible housing (e.g., a flexible tube, a plunger) that defines a cavity fluidly coupled to the reservoir and includes an outlet valve adjacent the lens of the camera. The vehicle of examples disclosed herein includes a washer fluid controller that sends a signal to a solenoid coupled to the flexible housing to cause the solenoid to affect a cavity pressure by flexing the flexible housing. The outlet valve of the flexible housing opens to spray the washer fluid onto the lens upon the cavity pressure being greater than a predetermined threshold. To enable the lens of the camera to remain clean during operation of the vehicle, the washer fluid controller sends the signal that causes the flexible housing to spray the washer fluid upon a user (e.g., a driver) moving a wiper stalk switch to an activated position, a transmission position sensor detecting that a vehicle transmission is transitioning to a reverse gear, and/or an ignition switch sensor detecting that a vehicle ignition switch is transitioning to an on-position.

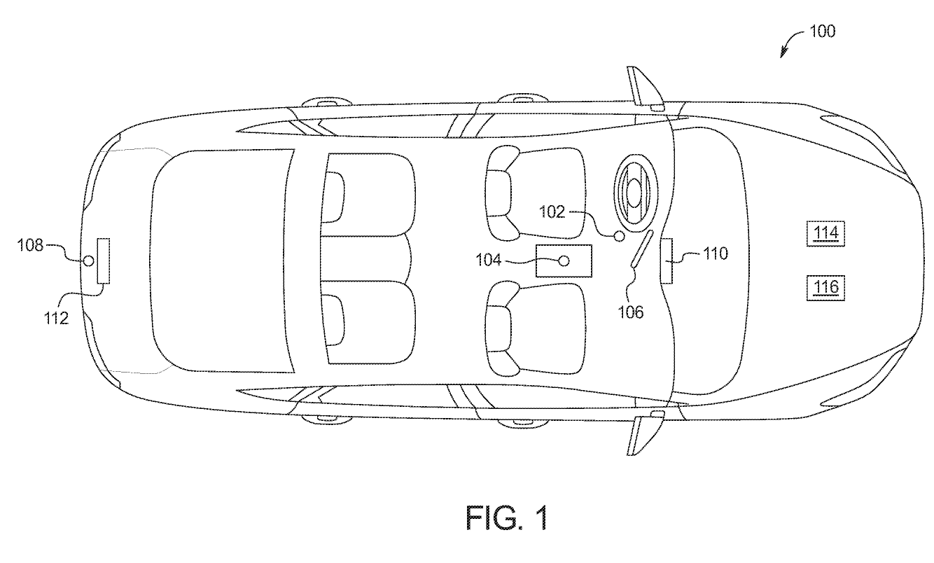

Turning to the figures, FIG. 1 illustrates an example vehicle 100 in accordance with the teachings herein. The vehicle 100 may be a standard gasoline powered vehicle, a hybrid vehicle, an electric vehicle, a fuel cell vehicle, and/or any other mobility implement type of vehicle. The vehicle 100 includes parts related to mobility, such as a powertrain with an engine, a transmission, a suspension, a driveshaft, and/or wheels, etc. The vehicle 100 may be non-autonomous, semi-autonomous (e.g., some routine motive functions controlled by the vehicle 100), or autonomous (e.g., motive functions are controlled by the vehicle 100 without direct driver input). In the illustrated example, the vehicle 100 includes an ignition switch 102, a gear stick 104, a wiper stalk switch 106, a camera 108, and a display 110.

The ignition switch 102 is utilized by a driver and/or another occupant of the vehicle 100 to operate an engine, a battery, and/or electronic accessories of the vehicle 100. For example, the driver inserts a key into the ignition switch 102 and turns and/or otherwise actuates the ignition switch 102 to a start position to activate the engine of the vehicle 100. Upon activating the engine, the driver facilitates the ignition switch 102 in turning and/or otherwise actuating to an on-position at which power is supplied to the engine and the electronic accessories. To deactivate the engine, the driver turns and/or otherwise actuates the ignition switch 102 to the off-position. Additionally, to activate the electronic accessories (e.g., the camera 108, the display 110, etc.) of the vehicle 100 without activating the engine, the driver may turn the ignition switch 102 to the accessory position. In some examples, the ignition switch 102 is a rotary switch that rotates between its positions. In other examples, the ignition switch 102 is be a pushbutton (e.g., the pushbutton is pushed once to be in the on-position and twice in succession to be in the accessory position).

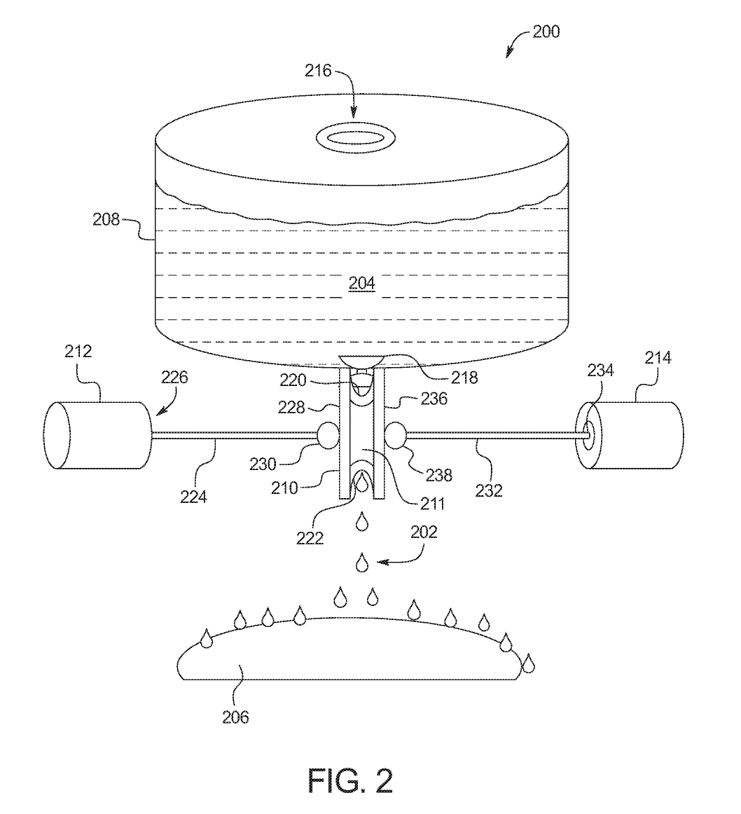

The gear stick 104 of the vehicle 100 is utilized to shift between gears (e.g., neutral, reverse, first gear, second gear, etc.) and/or modes (e.g., park, reverse, neutral, drive) of a transmission of the vehicle 100. The wiper stalk switch 106 is located adjacent to the ignition switch 102 and/or a steering wheel of the vehicle 100 to enable a driver to activate, deactivate, and/or adjust a washer fluid setting. For example, the driver may move the wiper stalk switch 106 to an activated position to cause washer fluid (e.g., washer fluid 204 of FIG. 2) to be sprayed and/or otherwise applied to windshield(s) (e.g., a front windshield, a rear windshield) and/or camera(s) (e.g. the camera 108) of the vehicle 100.

Further, the camera 108 is a rearview or backup camera that is located on an exterior of the vehicle 100 to monitor an area behind the vehicle 100. The camera 108 captures image(s) and/or video that are utilized to monitor an area behind the vehicle 100 (e.g., to facilitate autonomous and/or semi-autonomous motive functions such as remote park-assist). In other examples, the camera 108 and/or one or more other cameras may be located at other locations along the exterior of the vehicle 100 (e.g., toward the front, on a driver-side, on a passenger-side, etc.) to monitor areas adjacent to (e.g., in front of, to the left of, to the right of) the vehicle 100. The display 110 presents image(s) and/or video to the driver and/or any other occupant of the vehicle 100. In some examples, the display 110 presents the image(s) and/or video captured by the camera 108 to facilitate the driver in viewing an area behind the vehicle 100 when the gear stick 104 and, thus, the transmission of the vehicle 100 is in reverse.

The vehicle 100 of the illustrated example also includes a washer fluid module 112, a body control module 114, and a washer fluid controller 116. The washer fluid module 112 applies the washer fluid to the camera 108 to remove dirt and/or other material that has collected on a lens (e.g., a lens 206 of FIGS. 2-4) of the camera 108. As illustrated in FIG. 2, the washer fluid module 112 is positioned adjacent to the camera 108 to enable the washer fluid module 112 to spray and/or otherwise apply the washer fluid onto the lens of the camera 108. The body control module 114 controls one or more subsystems throughout the vehicle 100, such as power windows, power locks, an immobilizer system, power mirrors, etc. For example, the body control module 114 includes circuits that drive one or more of relays, brushed direct current (DC) motors (e.g., to control power seats, power locks, power windows, wipers, etc.), stepper motors, LEDs, etc. Further, the washer fluid controller 116 of the illustrated example controls operation of the washer fluid module 112. For example, the washer fluid controller 116 is communicatively coupled to and sends signal(s) to the washer fluid module 112 to cause the washer fluid module 112 to start and/or stop applying the washer fluid to the camera 108.

FIG. 2 illustrates an example washer fluid module 200 of the vehicle 100 (e.g., the washer fluid module 112). For example, the washer fluid module 200 sprays and/or applies droplets 202 of washer fluid 204 onto a lens 206 of the camera 108 and/or any other camera. As illustrated in FIG. 2, the washer fluid module 112 includes a reservoir 208, a flexible housing 210 defining a cavity 211, a solenoid 212 (e.g., a first solenoid), and another solenoid 214 (e.g., a second solenoid).

The reservoir 208 contains a mixture of the washer fluid 204 and air that is to be sprayed onto the lens 206 of the camera 108 via the flexible housing 210. In the illustrated example, the reservoir 208 includes an inlet 216 and an outlet valve 218. The inlet 216 is accessible to a user to facilitate the reservoir 208 in being refilled with the washer fluid 204 over time. In some examples, the reservoir 208 includes a sensor (e.g., a floating level sensor) to detect when the washer fluid 204 within the reservoir 208 is at a predetermined low level. The outlet valve 218 enables the mixture of the washer fluid 204 and air to flow from the reservoir 208. For example, the outlet valve 218 is a one-way gateway valve that enables the washer fluid 204, air, a mixture thereof and/or any other fluid(s) to flow from the reservoir 208 and prevents fluid from flowing into the reservoir 208 via the outlet valve 218. In some examples, the outlet valve 218 is operatively controlled via a lever or blade (e.g., a blinker blade) that pushes the outlet valve 218 open and/or pulls the outlet valve 218 closed. For example, the washer fluid controller 116 controls the lever or blade to control the outlet valve 218 of the reservoir 208.

In the illustrated example, the flexible housing 210 is a flexible tube that is located external to the reservoir 208. The flexible housing 210 includes an inlet valve 220 at a first end of the flexible housing 210. Further, the flexible housing 210 includes an outlet valve 222 at an opposing second end of the flexible housing 210 that is adjacent to the lens 206 of the camera 108. In the illustrated example, the first end of the flexible housing 210 is coupled to reservoir 208 such that the cavity 211 of the flexible housing 210 is fluidly coupled to the reservoir 208 via the outlet valve 218 of the reservoir 208 and the inlet valve 220 of the flexible housing 210. The inlet valve 220 of the illustrated example is a one-way inlet valve that enables fluid (e.g., the washer fluid 204, air, and/or a mixture thereof) to flow into the cavity 211 of the flexible housing 210 from the outlet valve 218 of the reservoir 208 an prevents fluid within the cavity 211 from flowing from the cavity 211 through the inlet valve 220. Further, the outlet valve 222 is a one-way outlet valve that enables fluid (e.g., the washer fluid 204, air, and/or a mixture thereof) to flow and/or be sprayed from the flexible housing 210 (e.g., onto the lens 206) and prevents fluid from flowing into the cavity 211 of the flexible housing 210 via the outlet valve 222.

As illustrated in FIG. 2, the solenoid 212 and the solenoid 214 are coupled to the flexible housing 210 to affect a pressure within the cavity 211 (e.g., a cavity pressure) of the flexible housing 210. For example, a connecting arm 224 (e.g., a first connecting arm) is coupled to an armature 226 (e.g., a first armature) of the solenoid 212 and a first side 228 of the flexible housing 210 to operatively couple the solenoid 212 to the flexible housing 210. In the illustrated example, the connecting arm 224 couples to the first side 228 of the flexible housing 210 via a connection point 230 (e.g., a first connection point). In other examples, the solenoid 212 may be operatively coupled to the flexible housing 210 via a wire. Further, a connecting arm 232 (e.g., a second connecting arm) is coupled to an armature 234 (e.g., a second armature) of the solenoid 214 and a second side 236 of the flexible housing 210 to operatively couple the solenoid 214 to the flexible housing 210. In the illustrated example, the connecting arm 232 couples to the first side 228 of the flexible housing 210 that is opposite the first side 228 via a connection point 238 (e.g., a second connection point). In other examples, the solenoid 212 may be operatively coupled to the flexible housing 210 via a wire. Further, in other examples, the washer fluid module 112 may include any other mechanism to affect the pressure within the cavity 211 of the flexible housing 210.

In operation, the washer fluid controller 116 is communicatively coupled to the solenoid 212 and/or the solenoid 214 to operate the solenoid 212 and/or the solenoid 214. For example, the washer fluid controller 116 sends a signal to the solenoid 212 to cause the armature 226 of the solenoid 212 to actuate. Actuation of the armature 226 causes the connecting arm 224 coupled to the armature 226 to move (e.g., slide), thereby causing the first side 228 of the flexible housing 210 to flex inward and/or outward. Additionally or alternatively, the washer fluid controller 116 sends a signal to the solenoid 214 to cause the armature 234 of the solenoid 214 to actuate. Actuation of the armature 234 causes the connecting arm 232 coupled to the armature 234 to move (e.g., slide), thereby causing the second side 236 of the flexible housing 210 to flex inward and/or outward.

The solenoid 212 and/or the solenoid 214 flex the flexible housing 210 to affect a pressure within the cavity 211 of the flexible housing 210. For example, when the solenoid 212 and/or the solenoid 214 compresses the flexible housing 210 (e.g., flexes the flexible housing 210 inward), the solenoid 212 and/or the solenoid 214 squeeze the flexible housing 210 to increase the pressure within the cavity 211 by decreasing a volume of the cavity 211. Upon the pressure within the cavity 211 being greater than a predetermined pressure, the outlet valve 222 of the flexible housing 210 opens to spray the washer fluid 204, air, and/or a mixture thereof disposed within the cavity 211 of the flexible housing 210 onto the lens 206 of the camera 108. In some examples, a nozzle geometry of the outlet valve 222 increases a fluid velocity of the washer fluid 204, air, and/or a mixture thereof being sprayed to facilitate washing of the lens 206 of the camera 108. For example, the inertia of the fluid and/or gravity causes the fluid sprayed onto the lens 206 to wash off of the lens 206 to facilitate cleaning of the lens 206. Further, in some examples, the inlet valve 220 of the flexible housing 210 closes when the pressure within the cavity 211 is greater than the predetermined pressure. That is, the inlet valve 220 is closed when the outlet valve 222 is opened. The inlet valve 220 closes when the outlet valve 222 opens to limit and/or otherwise control the amount of fluid sprayed from the flexible housing 210 by preventing fluid from continuously flowing through the flexible housing 210 from the reservoir 208.

Additionally, when the solenoid 212 and/or the solenoid 214 expands the flexible housing 210 (e.g., flexes the flexible housing 210 outward), the solenoid 212 and/or the solenoid 214 squeeze the flexible housing 210 to decrease the pressure within the cavity 211 by increasing the volume of the cavity 211. Upon the pressure within the cavity 211 being less than or equal to the predetermined pressure, the outlet valve 222 closes and the inlet valve 220 opens. That is, the inlet valve 220 is opened when the outlet valve 222 is closed. The inlet valve 220 opens and the outlet valve 222 closes to enable a portion of the washer fluid 204, air, and/or a mixture thereof stored in the reservoir 208 to flow into and collect within the cavity 211 of the flexible housing 210 (e.g., that is sprayed via the outlet valve 222 at a later time).

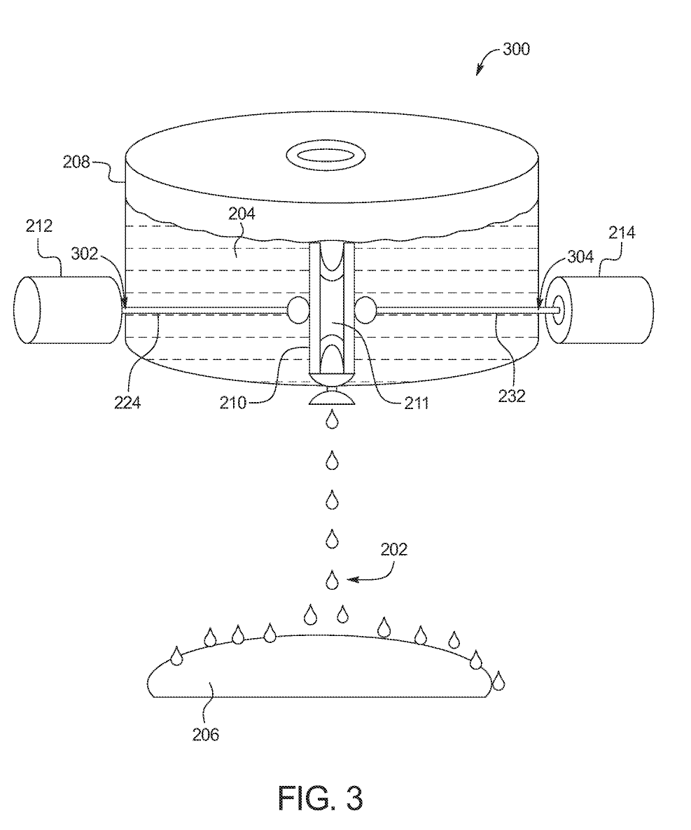

FIG. 3 illustrates another example washer fluid module 300 of the vehicle 100 (e.g., the washer fluid module 112) that sprays and/or applies the droplets 202 of the washer fluid 204 onto the lens 206 of the camera 108. The washer fluid module 300 of FIG. 3 includes the reservoir 208, the flexible housing 210, the solenoid 212, the solenoid 214, the connecting arm 224, and the connecting arm 232 that are substantially similar and/or identical to the reservoir 208, the flexible housing 210, the solenoid 212, the solenoid 214, the connecting arm 224, and the connecting arm 232 of the washer fluid module 200 of FIG. 2. Because those components has been discussed in detail with respect to FIG. 2, some features of the reservoir 208, the flexible housing 210, the solenoid 212, the solenoid 214, the connecting arm 224, and the connecting arm 232 will not be discussed in further detail below

In the illustrated example, the flexible housing 210 is a flexible tube that is disposed within the reservoir 208. For example, the flexible housing 210 is disposed within the reservoir 208 to reduce a size of the washer fluid module 300 and/or to prevent the flexible housing 210 from becoming dislodged from the reservoir 208. Further, the solenoid 212 and the solenoid 214 that affect the pressure of the cavity 211 of the flexible housing 210 are external to the reservoir 208. As illustrated in FIG. 3, the reservoir 208 defines an aperture 302 through which the connecting arm 224 extends to enable the connecting arm 224 to operatively couple the solenoid 212 external to the reservoir 208 and the flexible housing 210 disposed within the reservoir 208. In some examples, a seal is formed between the connecting arm 224 and the reservoir 208 at the aperture 302 to prevent the washer fluid 204 from flowing through the aperture 302. Additionally, the reservoir 208 defines an aperture 304 through which the connecting arm 232 extends to enable the connecting arm 232 to operatively couple the solenoid 214 external to the reservoir 208 and the flexible housing 210 disposed within the reservoir 208. In some examples, a seal is formed between the connecting arm 232 and the reservoir 208 at the aperture 304 to prevent the washer fluid 204 from flowing through the aperture 304.

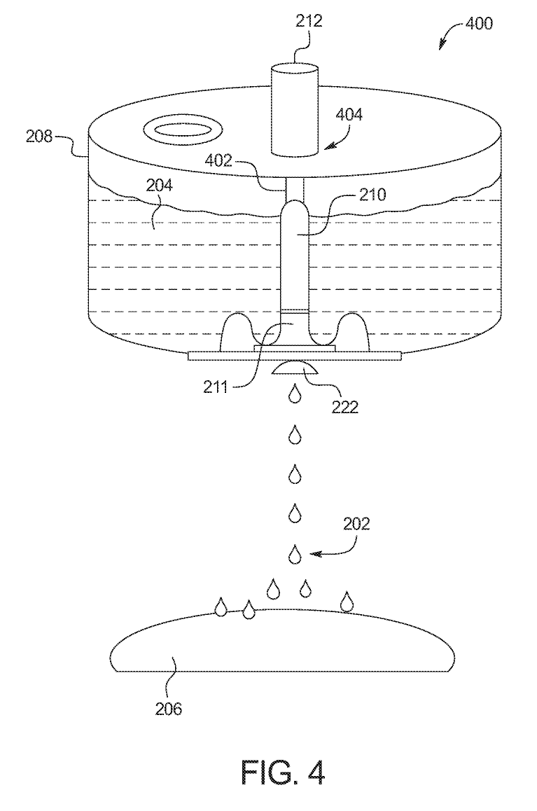

FIG. 4 illustrates another example washer fluid module 400 of the vehicle 100 (e.g., the washer fluid module 112) that sprays and/or applies the droplets 202 of the washer fluid 204 onto the lens 206 of the camera 108. The washer fluid module 400 of FIG. 4 includes the reservoir 208, the flexible housing 210, and the solenoid 212 that are substantially similar and/or identical to the reservoir 208, the flexible housing 210, and the solenoid 212 of the washer fluid module 200 of FIG. 2. Because those components has been discussed in detail with respect to FIG. 2, some features of the reservoir 208, the flexible housing 210, and the solenoid 212 will not be discussed in further detail below.

In the illustrated example, the flexible housing 210 is a plunger that is disposed within the reservoir 208. For example, the flexible housing 210 is disposed within the reservoir 208 to reduce a size of the washer fluid module 300 and/or to prevent the flexible housing 210 from becoming dislodged from the reservoir 208. As illustrated in FIG. 4, the solenoid 212 that affects the pressure of the cavity 211 of the flexible housing 210 is external to the reservoir 208. The solenoid 212 is coupled to the flexible housing 210 via a connecting arm 402. The reservoir 208 defines an aperture 404 through which the connecting arm 402 extends to enable the connecting arm 402 to operatively couple the solenoid 212 external to the reservoir 208 and the flexible housing 210 disposed within the reservoir 208. In some examples, a seal is formed between the connecting arm 402 and the reservoir 208 at the aperture 404 to prevent the washer fluid 204 from flowing through the aperture 302. In operation, the outlet valve 222 sprays the washer fluid 204, air, and/or a mixture thereof when the solenoid 212 compresses the cavity 211 of the plunger via the connecting arm 402. Further, the cavity 211 of the plunger receives the washer fluid 204, air, and/or a mixture thereof from the reservoir 208 (e.g., via a vent of the plunger) when the solenoid 212 expands the cavity 211 of the plunger via the connecting arm 402.

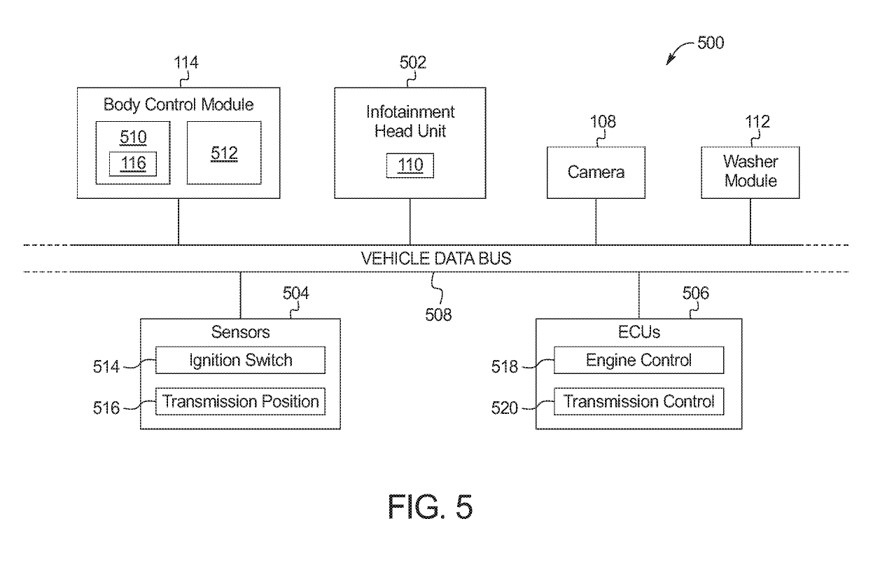

FIG. 5 is a block diagram of electronic components 500 of the vehicle of FIG. 1. As illustrated in FIG. 5, the electronic components 500 include the body control module 114, an infotainment head unit 502, the camera 108, the washer fluid module 112 (e.g., the washer fluid module 200, the washer fluid module 300, washer fluid module 400), sensors 504, electronic control units (ECUs) 506, and a vehicle data bus 508.

The body control module 114 includes a microcontroller unit, controller or processor 510 and memory 512. In some examples, the processor 510 of the body control module 114 is structured to include the washer fluid controller 116. Alternatively, in some examples, the washer fluid controller 116 is incorporated into another electronic control unit (ECU) with its own processor 510 and memory 512. The processor 510 may be any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). The memory 512 may be volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory 512 includes multiple kinds of memory, particularly volatile memory and non-volatile memory.

The memory 512 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 512, the computer readable medium, and/or within the processor 510 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The infotainment head unit 502 provides an interface between the vehicle 100 and a user. The infotainment head unit 502 includes digital and/or analog interfaces (e.g., input devices and output devices) to receive input from and display information for the user(s). The input devices include, for example, a control knob, an instrument panel, a digital camera for image capture and/or visual command recognition, a touch screen, an audio input device (e.g., cabin microphone), buttons, or a touchpad. The output devices may include instrument cluster outputs (e.g., dials, lighting devices), actuators, a heads-up display, a center console display (e.g., a liquid crystal display (LCD), an organic light emitting diode (OLED) display, a flat panel display, a solid state display, etc.) such as the display 110, and/or speakers. In the illustrated example, the infotainment head unit 502 includes hardware (e.g., a processor or controller, memory, storage, etc.) and software (e.g., an operating system, etc.) for an infotainment system (such as SYNC® and MyFord Touch® by Ford®, Entune® by Toyota®, IntelliLink® by GMC®, etc.). Additionally, the infotainment head unit 502 displays the infotainment system on, for example, the display 110.

The sensors 504 are arranged in and around the vehicle 100 to monitor properties of the vehicle 100 and/or an environment in which the vehicle 100 is located. One or more of the sensors 504 may be mounted to measure properties around an exterior of the vehicle 100. Additionally or alternatively, one or more of the sensors 504 may be mounted inside a cabin of the vehicle 100 or in a body of the vehicle 100 (e.g., an engine compartment, wheel wells, etc.) to measure properties in an interior of the vehicle 100. For example, the sensors 504 include accelerometers, odometers, tachometers, pitch and yaw sensors, wheel speed sensors, microphones, tire pressure sensors, biometric sensors and/or sensors of any other suitable type. In the illustrated example, the sensors 504 include an ignition switch sensor 514 and a transmission position sensor 516. For example, the ignition switch sensor 514 detects a position at which the ignition switch 102 is positioned (e.g., an off-position, a start position, an on-position, an accessories position). Further, the transmission position sensor 516 detects a position at which the gear stick 104 is positioned (e.g., at park, in reverse, in forward, etc.) to determine whether the vehicle 100 is stationary, travelling in reverse, or travelling forward.

The ECUs 506 monitor and control the subsystems of the vehicle 100. For example, the ECUs 506 are discrete sets of electronics that include their own circuit(s) (e.g., integrated circuits, microprocessors, memory, storage, etc.) and firmware, sensors, actuators, and/or mounting hardware. The ECUs 506 communicate and exchange information via a vehicle data bus (e.g., the vehicle data bus 508). Additionally, the ECUs 506 may communicate properties (e.g., status of the ECUs 506, sensor readings, control state, error and diagnostic codes, etc.) to and/or receive requests from each other. For example, the vehicle 100 may have seventy or more of the ECUs 506 that are positioned in various locations around the vehicle 100 and are communicatively coupled by the vehicle data bus 508. In the illustrated example, the ECUs 506 include an engine control unit 518 and a transmission control module 520. For example, the engine control unit 518 includes the ignition switch sensor 514, collects ignition switch and/or engine data, sends data to the washer fluid module 112, and/or receives control signal(s) to control operation (e.g., remote starting) of an engine of the vehicle 100. The transmission control module 520 includes the transmission position sensor 516, collects transmission data, sends data to the washer fluid module 112, and/or receives control signal(s) to control operation of a transmission of the vehicle 100.

The vehicle data bus 508 communicatively couples the camera 108, the washer fluid module 112, the body control module 114, the infotainment head unit 502, the sensors 504, and the ECUs 506. In some examples, the vehicle data bus 508 includes one or more data buses. The vehicle data bus 508 may be implemented in accordance with a controller area network (CAN) bus protocol as defined by International Standards Organization (ISO) 11898-1, a Media Oriented Systems Transport (MOST) bus protocol, a CAN flexible data (CAN-FD) bus protocol (ISO 11898-7) and/a K-line bus protocol (ISO 9141 and ISO 14230-1), and/or an Ethernet™ bus protocol IEEE 802.3 (2002 onwards), etc.

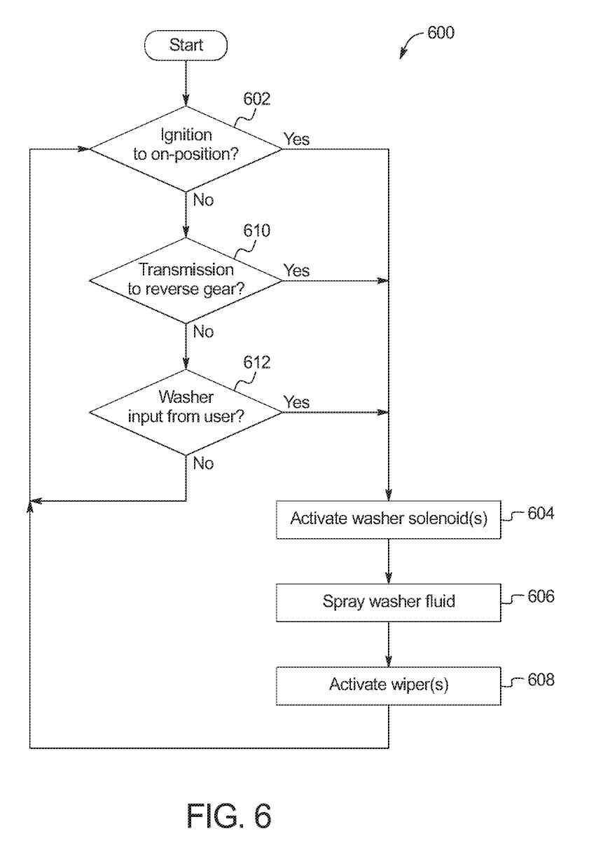

FIG. 6 is a flowchart of an example method 600 to apply washer fluid to a camera of a vehicle. The flowchart of FIG. 6 is representative of machine readable instructions that are stored in memory (such as the memory 512 of FIG. 5) and include one or more programs which, when executed by a processor (such as the processor 510 of FIG. 5), cause the vehicle 100 to implement the example washer fluid controller 116 of FIGS. 1 and 5. While the example program is described with reference to the flowchart illustrated in FIG. 6, many other methods of implementing the example washer fluid controller 116 may alternatively be used. For example, the order of execution of the blocks may be rearranged, changed, eliminated, and/or combined to perform the method 600. Further, because the method 600 is disclosed in connection with the components of FIGS. 1-5, some functions of those components will not be described in detail below.

Initially, at block 602, the washer fluid controller 116 determines whether the ignition switch 102 is transitioning to the on-position (e.g., from the off-position, the start position, the accessory position). For example, the washer fluid controller 116 determines the position of the ignition switch 102 via the ignition switch sensor 514 that detects the position of the ignition switch 102. In response to the washer fluid controller 116 determining that the ignition switch 102 is transitioning to the on-position, the method 600 proceeds to block 604.

At block 604, the washer fluid controller 116 sends a signal to one or more solenoids (e.g., the solenoid 212 and/or the solenoid 214 of FIG. 2) to cause corresponding armature(s) (e.g., the armature 226 and/or the armature 234 of FIG. 2) coupled to the flexible housing 210 to flex the flexible housing 210. For example, the washer fluid controller 116 cause the solenoid(s) to flex the flexible housing 210 to affect a pressure within the cavity 211 (e.g., a cavity pressure) of the flexible housing 210. At block 606, the washer fluid module 112 sprays the washer fluid 204, air, and/or a mixture thereof onto the lens 206 of the camera 108 (e.g., the camera lens) when the pressure within the cavity 211 of the flexible housing 210 is greater than a predetermined threshold. For example, the outlet valve 222 of the flexible housing 210 is opened upon the pressure within the cavity 211 being greater than the predetermined threshold to spray the lens 206 of the camera 108 with the droplets 202 of the washer fluid 204. That is, the washer fluid controller 116 sends the signal to cause the solenoid 212 and/or the solenoid 214 to spray the washer fluid 204, air, and/or a mixture thereof via the outlet valve 222 when the ignition switch sensor 514 detects that the ignition switch 102 is transitioning to the on-position. In some examples, the inlet valve 220 of the flexible housing 210 is closed upon the pressure within the cavity 211 being greater than the predetermined threshold to limit the amount of the washer fluid 204 that the flexible housing 210 sprays when the outlet valve 222 is opened. Further, in some examples, the washer fluid controller 116 activates wiper(s) upon the washer fluid module 112 spraying the lens 206 of the camera 108 to remove the washer fluid 204 from lens 206 of the camera 108 (block 608). Upon executing block 608, the method 600 returns to block 602.

Otherwise, in response to the washer fluid controller 116 determining at block 602 that the ignition switch 102 is not transitioning to the on-position, the method 600 proceeds to block 610 at which the washer fluid controller 116 determines whether the transmission is transitioning to a reverse gear (e.g., from neutral, drive, etc.). For example, the washer fluid controller 116 identifies the position of the gear stick 104 via the transmission position sensor 516 that monitors the position of the gear stick 104 to detect when the transmission is transitioning to the reverse gear. In response to the washer fluid controller 116 determining that the transmission is transitioning to the reverse gear, the method 600 proceeds to block 604. At block 604 and block 606, the washer fluid controller 116 sends the signal to cause the solenoid 212 and/or the solenoid 214 to spray the washer fluid 204, air, and/or a mixture thereof via the outlet valve 222 when the transmission position sensor 516 detects that the transmission is transitioning (e.g., via the gear stick 104) to a reverse gear. Otherwise, in response to the washer fluid controller 116 determining that the transmission is not transitioning to the reverse gear, the method 600 proceeds to block 612.

At block 612, the washer fluid controller 116 determines whether the transmission is receiving an input from a user (e.g., the driver) to spray the washer fluid 204, air, and/or a mixture thereof onto the lens 206 of the camera 108. For example, the washer fluid controller 116 receives the instruction to spray the washer fluid 204, air, and/or a mixture thereof when the driver moves the wiper stalk switch 106 to an activated position. In response to the washer fluid controller 116 determining that the user is instructing the washer fluid module 112 to spray the washer fluid 204, air, and/or a mixture thereof, the method 600 proceeds to block 604. At block 604 and block 606, the washer fluid controller 116 sends the signal to cause the solenoid 212 and/or the solenoid 214 to spray the washer fluid 204, air, and/or a mixture thereof via the outlet valve 222 when the wiper stalk switch 106 is in the activated position. Otherwise, in response to the washer fluid controller 116 determining that the user is not instructing the washer fluid module 112 to spray the washer fluid 204, air, and/or a mixture thereof, the method 600 returns to block 602.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

1. A vehicle comprising:
a camera including a lens;
a reservoir;
a flexible housing defining a cavity fluidly coupled to the reservoir and including an outlet valve adjacent the lens; and
a solenoid coupled to the flexible housing to affect a cavity pressure by flexing the flexible housing, the outlet valve opens upon the cavity pressure being greater than a predetermined threshold to spray the washer fluid onto the lens.

2. The vehicle of claim 1, wherein the outlet valve is a one-way outlet valve.

3. The vehicle of claim 2, wherein the flexible housing further includes a one-way inlet valve that enables the cavity to receive the washer fluid from the reservoir, the one-way outlet valve is open when the one-way inlet valve is closed and the one-way outlet valve is closed when the one-way inlet valve is open.

4. The vehicle of claim 1, wherein the reservoir and the flexible housing contain and the outlet valve sprays a mixture of the washer fluid and air.

5. The vehicle of claim 1, wherein the solenoid includes an armature coupled to the flexible housing that actuates to cause the flexible housing to flex.

6. The vehicle of claim 5, further including a connecting arm to operatively couple the flexible housing and the solenoid.

7. The vehicle of claim 6, wherein the reservoir defines an aperture through which the connecting arm extends to operatively couple the solenoid that is external to the reservoir and the flexible housing that is disposed within the reservoir.

8. The vehicle of claim 1, wherein the flexible housing is a plunger disposed in the reservoir.

9. The vehicle of claim 1, wherein the flexible housing is a flexible tube including an inlet valve at a first end and the outlet valve at a second end opposite the first end.

10. The vehicle of claim 9, wherein the flexible tube is disposed within the reservoir.

11. The vehicle of claim 9, wherein the flexible tube is external to the reservoir.

12. The vehicle of claim 1, further including a second solenoid, the solenoid is coupled to a first side of the flexible housing and the second solenoid is coupled to a second side of the flexible housing opposite the first side to cause the flexible housing to flex when the solenoid and the second solenoid actuate.

13. The vehicle of claim 1, further including a washer fluid controller to operate the solenoid.

14. The vehicle of claim 13, further including an ignition switch and an ignition switch sensor, the washer fluid controller to cause the solenoid to spray the washer fluid via the outlet valve of the flexible housing when the ignition switch sensor detects that the ignition switch transitioned to an on-position.

15. The vehicle of claim 13, further including a transmission and a transmission position sensor, the washer fluid controller to cause the solenoid to spray the washer fluid via the outlet valve of the flexible housing when the transmission position sensor detects that the transmission has transitioned to a reverse gear.

16-20. (canceled)
